(19) United States
(12) Patent Application Publication
(10) Pub. No.: US 2008/0203823 A1
(43) Pub. Date: Aug. 28, 2008

(54) Arrangement for Converting Mechanical Energy Into Electrical Energy

(75) Inventors: Carsten Deppe, Aachen (DE); Thomas Durbaum, Baiersdorf (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 11/912,731

(22) PCT Filed: Apr. 21, 2006
(86) PCT No.: PCT/IB06/51239

§ 371 Date: Oct. 26, 2007

(30) Foreign Application Priority Data
Apr. 27, 2005 (EP) 05103448.6

(51) Int. Cl. H02N 2/18; H02N 1/00; H02J 5/00

(52) U.S. Cl. 307/78; 322/2 R; 322/2 A; 307/84

(57) ABSTRACT

The invention relates to an arrangement for converting mechanical energy into electrical energy comprising a piezo-electric auxiliary generator producing an auxiliary voltage and a main generator which is coupled mechanically with the auxiliary generator and producing the electrical energy.

The invention relates to an arrangement for converting mechanical energy into electrical energy.

An object of the invention is to supply autonomous devices with electrical energy by the use of vibrations and other movements. Such devices are called energy scavengers.

Components for converting mechanical energy into electrical energy can be based on electrodynamic, electrostatic or piezoelectric principle which have different properties relating to voltage, current, and additionally required circuitry.

The electrodynamic principle produces alternating voltage the amplitude of which is the lower the smaller the component is. The piezoelectric principle results in a high no-load voltage at low current capability. electrostatic generators require electronic circuitry and an initial load in order to produce electrical energy.

One object of the invention is to enable a mechanically driven generator which produces operating voltage preferably for electronic circuits and sensor devices. Another object of the invention is the possibility to realize the generator as miniaturized device.

The arrangement according to the invention comprises a piezoelectric auxiliary generator producing an auxiliary voltage and a main generator which is coupled mechanically with the auxiliary generator and producing the electrical energy.

In a first way of carrying out the invention the main generator is an electrodynamic generator and the auxiliary generator produces a supply voltage for a synchronous rectifier which converts an AC output of the electrodynamic generator into a DC voltage. Optionally the auxiliary generator further provides pulses for synchronizing the synchronous rectifier.

In a second way of carrying out the invention the main generator is an electrostatic generator and the auxiliary generator produces an initial charge for the main generator and a supply voltage for a control circuit. Optionally the auxiliary generator further provides pulses for synchronizing the control circuit.

In both cases the invention can be further developed wherein the electrical energy produced by the main generator is supplied to a converter and wherein an output of the converter is connected to a buffer battery. Optionally the buffer battery is connected with a DC output of the auxiliary generator by means of a rectifier diode.

These and other aspects of the invention will be apparent from and elucidated with reference to the embodiments described hereinafter.

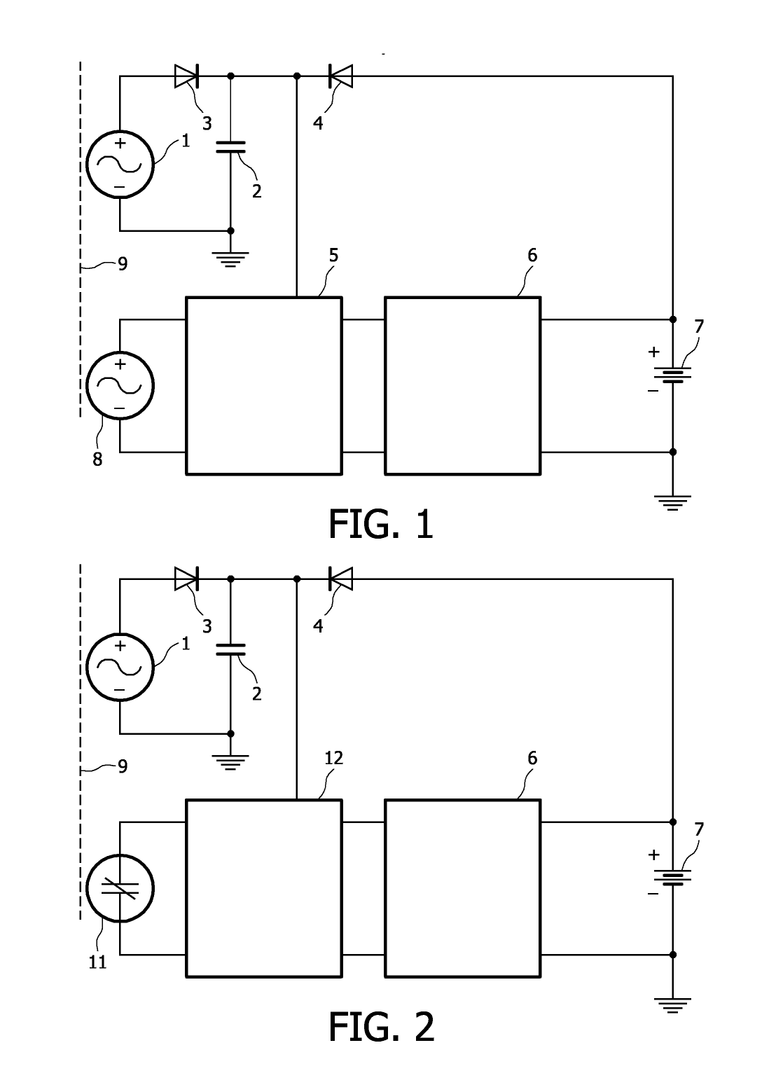

FIG. 1 is a block diagram of a first embodiment of the invention,

FIG. 2 is a block diagram of a second embodiment and

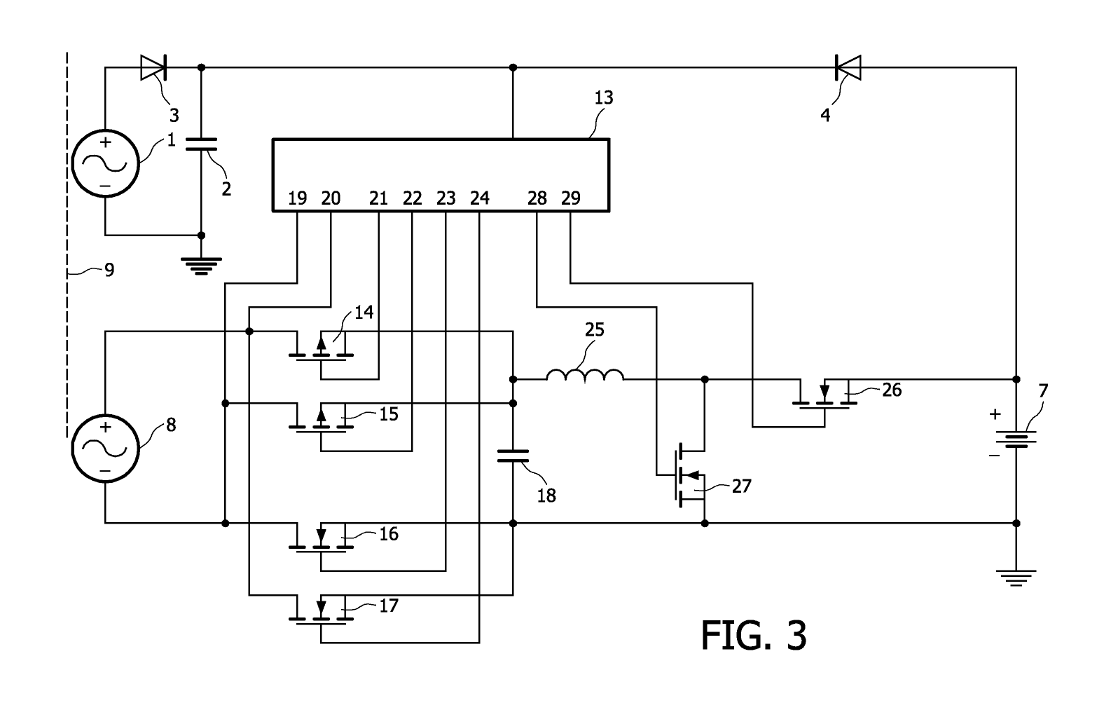

FIG. 3 is a presentation of the first embodiment in grater detail.

The embodiment according to FIG. 1 consists of a piezoelectric auxiliary generator 1 and a electrodynamic main generator 8. Both are coupled with each other by a mechanical structure 9 in order to provide mechanical input energy, e.g. vibration, to both generators. The auxiliary generator 1 produces a high voltage with a high internal resistance. Therefore the auxiliary generator 1 can produce only a very low current. The output voltage is rectified by a diode 3 and a capacitor 2.

The electrodynamic main generator 8 delivers an alternating voltage which is too low for semiconductor circuitry and for being rectified by usual diodes. Therefore the output voltage of the electrodynamic main generator 8 is rectified by a synchronous rectifier 5. The details of which are explained later in connection with FIG. 3. The output voltage of the synchronous rectifier 5 is converted by a boost converter 6 into a voltage of e.g. 3V which is supplied to a buffer battery 7.

In the embodiment according to FIG. 1 the rectified output voltage of the piezoelectric auxiliary generator is needed only in a start-up phase. Thereafter it is replaced by the voltage of the battery 7 via the diode 4. Notwithstanding the piezoelectric auxiliary generator 1 is advantageous because the battery 7 has not to hold the charge up to the next start-up.

In the embodiment according to FIG. 2 instead of an electrodynamic main generator 8 an electrostatic generator 11 is used. The electrical energy can be drawn by the change of the capacity of a capacitor which change again is caused by the mechanical drive. This principle requires an initial load and a control of current flow. These functions are performed in a control circuit 12 which gets the output voltage of the auxiliary generator 10 as an initial load and a supply voltage.

The output voltage of the control circuit 12 is converted by converter 6 into a voltage fitting to the not shown load, e.g. a semiconductor circuit. The auxiliary generator and the components 2, 3, 4, 7 are already described in connection with FIG. 1.

In FIG. 3 a control circuit 13 provides control pulses for the synchronous rectifier 5 and the boost converter 6 (FIG. 1). The synchronous rectifier 5 consists of four field effect transistors 14, 15, 16, 17 and a capacitor 18. The control circuit 13 has two inputs 19, 20 which receive the output voltage of the electrodynamic main generator 8 and derive control signals for the field effect transistors 14 to 16 which are connected to outputs 21, 22, 23, 24 of the control circuit 13. The boost converter 6 (FIG. 1) is realized by an inductor 25 and two further field effect transistors 26, 27. Both are controlled by control signals supplied by outputs 28, 29 of the control circuit 13.

As an alternative the control circuit 13 can be synchronized by the auxiliary generator 1. This requires phase stable coupling 9 between both generators 1, 8.

1. Arrangement for converting mechanical energy into electrical energy comprising a piezoelectric auxiliary generator producing an auxiliary voltage and a main generator which is coupled mechanically with the auxiliary generator and producing the electrical energy.

2. Arrangement according to claim 1 wherein the main generator is an electrodynamic generator and wherein the auxiliary generator produces a supply voltage for a synchronous rectifier which converts an AC output of the electrodynamic generator into a DC voltage.

3. Arrangement according to claim 2 wherein the auxiliary generator further provides pulses for synchronizing the synchronous rectifiers.

4. Arrangement according to claim 1 wherein the main generator is an electrostatic generator and wherein the auxiliary generator produces an initial charge for the main generator and a supply voltage for a control circuit.

5. Arrangement according to claim 4 wherein the auxiliary generator further provides pulses for synchronizing the control circuit.

6. Arrangement according to claims 2 wherein the electrical energy produced by the main generator supplied to a converter and wherein an output of the converter is connected to a buffer battery.

7. Arrangement according to claim 6 wherein the buffer battery is connected with a DC output of the auxiliary generator by means of a rectifier diode.
